(19) United States
(12) Patent Application Publication
(10) Pub. No.: US 2018/0251062 A1
(43) Pub. Date: Sep. 6, 2018

(54) Portable Lift

(71) Applicant: William Touchstone, Flora, MS (US)

(72) Inventor: William Touchstone, Flora, MS (US)

(21) Appl. No.: 15/485,425

(22) Filed: Apr. 12, 2017

Related U.S. Application Data
(60) Provisional application No. 62/465,220, filed on Mar. 1, 2017.

(51) Int. Cl. B60P 1/64; B66F 9/20; B66F 9/12; B66F 9/08; B66F 9/075

(52) U.S. Cl. CPC B60P 1/6409; B66F 9/20; B66F 9/07559; B66F 9/087; B66F 9/12

(57) ABSTRACT

A portable lift may attach to a hitch of a vehicle. The portable lift may include an attachment member configured to engage the hitch. An elevation member may include a proximal end and a distal end opposite the proximal end. The proximal end of the elevation member may be connected to the attachment member. A platform may be slidably disposed on the elevation member. A pulley may be disposed nearer the distal end than the proximal end of the elevation member. A winch may be configured to move the platform up and down on the elevation member. The winch may include a cable connected to the platform and engaging the pulley.

### BACKGROUND

The present disclosure relates generally to a portable lift. More particularly, the present disclosure pertains to a portable lift that may attach to the hitch of a vehicle.

Cherry pickers, scaffolding, and other lifting devices are known in the art. None of these devices are easily transported or deployed. Further, certain tasks such as lifting roofing shingles above the edge of a roof, cleaning gutters, and the like may not be worth renting a cherry picker to the average person.

What is needed, therefore, is a portable lift that can be deployed quickly and easily.

### BRIEF SUMMARY

Briefly, the present disclosure relates, in one embodiment, to a portable lift that may attach to a hitch of a vehicle. The portable lift may include an attachment member configured to engage the hitch. An elevation member may include a proximal end and a distal end opposite the proximal end. The proximal end of the elevation member may be connected to the attachment member. A platform may be slidably disposed on the elevation member. A pulley may be disposed nearer the distal end than the proximal end of the elevation member. A winch may be configured to move the platform up and down on the elevation member. The winch may include a cable connected to the platform and engaging the pulley.

In any embodiment, a load dispersal member may be connected to at least one of the attachment member and the elevation member. The load dispersal member may include a foot configured to engage a ground surface to transfer at least some downward force into the ground surface.

In any embodiment, at least one stabilizer member may be connected to the elevation member. The at least one stabilizer member may be configured to attach to the vehicle to stabilize the elevation member.

In any embodiment, the winch may include an electric winch.

In any embodiment, the winch may be configured to receive electrical energy from the vehicle.

In any embodiment, the portable lift may further include a battery. The winch may be configured to receive electrical energy from the battery.

In any embodiment, the platform may include railing along at least some of the perimeter of the platform.

### BRIEF DESCRIPTION OF THE DRAWINGS

FIG. 1 is a perspective view of one embodiment of the portable lift attached to the hitch of a vehicle and in the elevated position with cargo on the platform above a roof of a building.

FIG. 2 is a rear perspective view of the portable lift of FIG. 1 attached to the hitch of a vehicle and in the elevated position with cargo on the platform.

FIG. 3 is a detailed left side perspective view of the portable lift of FIG. 1 attached to the hitch of a vehicle.

FIG. 4 is a detailed left side perspective view of the pulley of the portable lift of FIG. 1

FIG. 5 is a detailed right side perspective view of the pulley of the portable lift of FIG. 1.

FIG. 6 is a detailed right side perspective view of the portable lift of FIG. 1 attached to the hitch of a vehicle.

FIG. 7 is a detailed right side perspective view of the portable lift of FIG. 1 attached to the hitch of a vehicle, the portable lift having a different load dispersal member.

FIG. 8 is a right side perspective view of the portable lift of FIG. 1 attached to the hitch of a vehicle and in the lowered position with the load dispersal member in the retracted position.

FIG. 9 is a detailed right side perspective view of the portable lift of FIG. 1 attached to the hitch of a vehicle with the load dispersal member in the retracted position.

FIG. 10 is a perspective view of the portable lift of FIG. 1 unassembled.

FIG. 11 is a top perspective view of an embodiment of the sleeve member on the elevation member.

FIG. 12 is a bottom perspective view of the sleeve member of FIG. 11 on the elevation member.

FIG. 13 is a bottom plan view of the sleeve member of FIG. 11.

FIG. 14 is a right side perspective view of the portable lift of FIG. 1 including a height extender.

FIG. 15 is a right side perspective view of the portable lift of FIG. 1 including a pallet engagement attachment.

FIG. 16 is a perspective view of the portable lift of FIG. 1. connected to the front of the vehicle.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

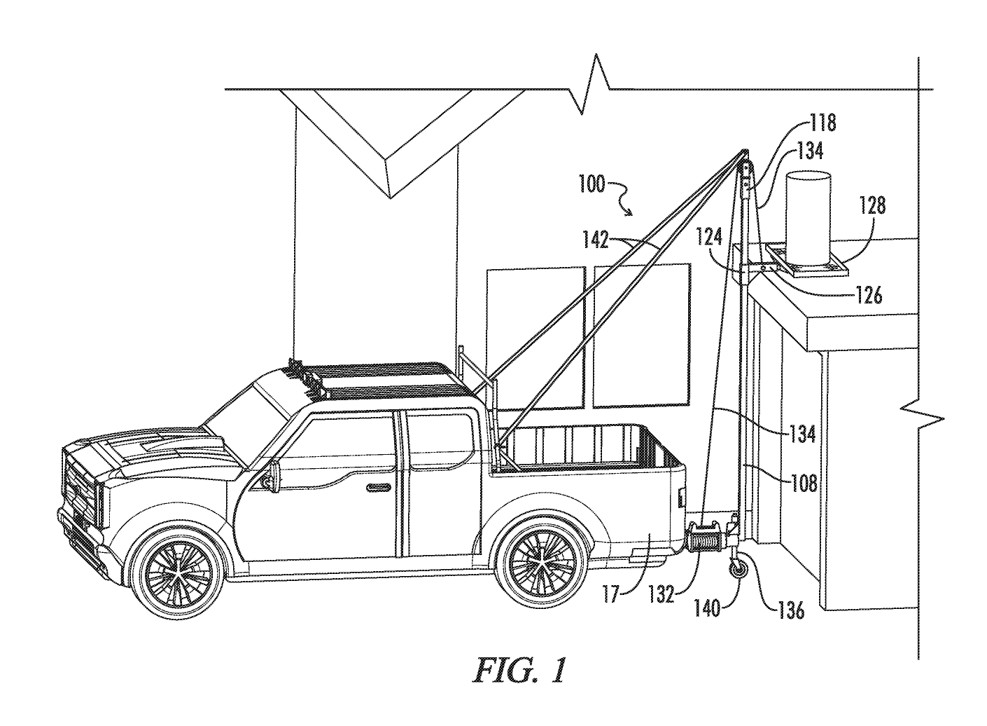

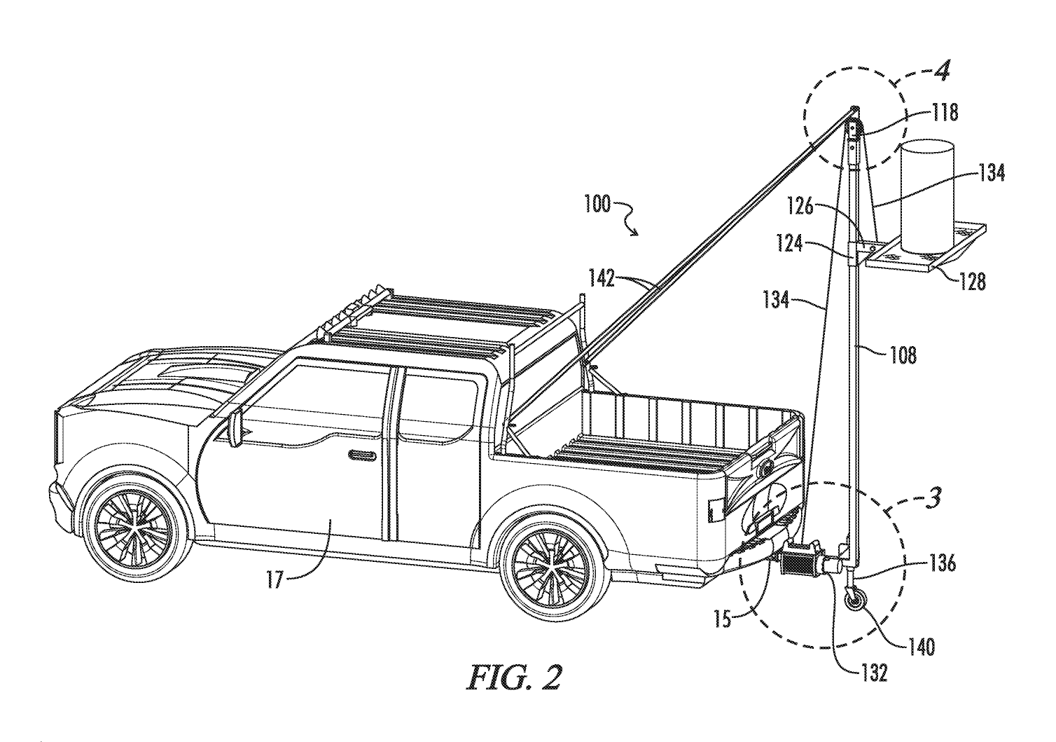

Referring to FIGS. 1 and 2, a portable lift assembly 100 is shown. The portable lift assembly 100 may attach to the hitch 15 of a vehicle 17.

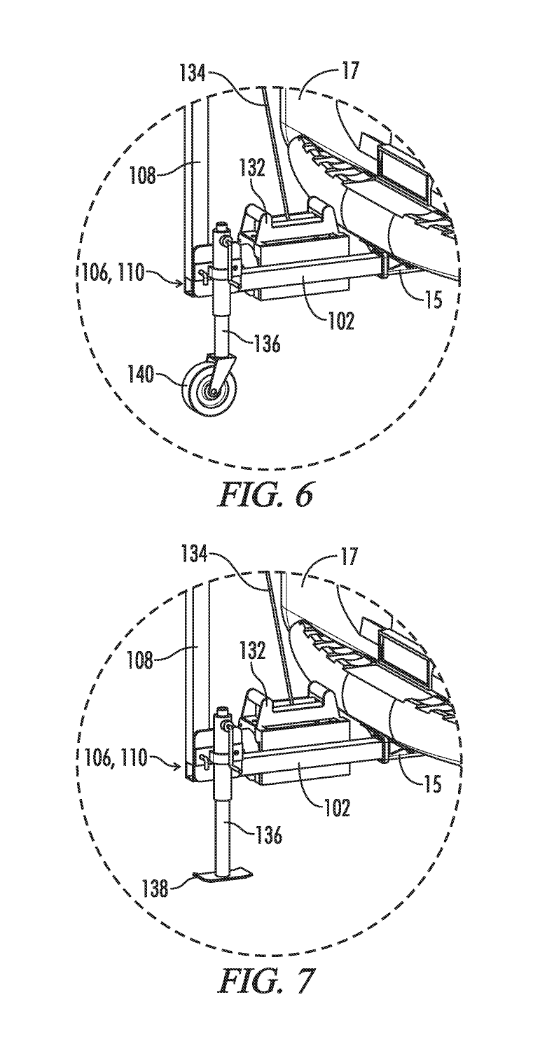

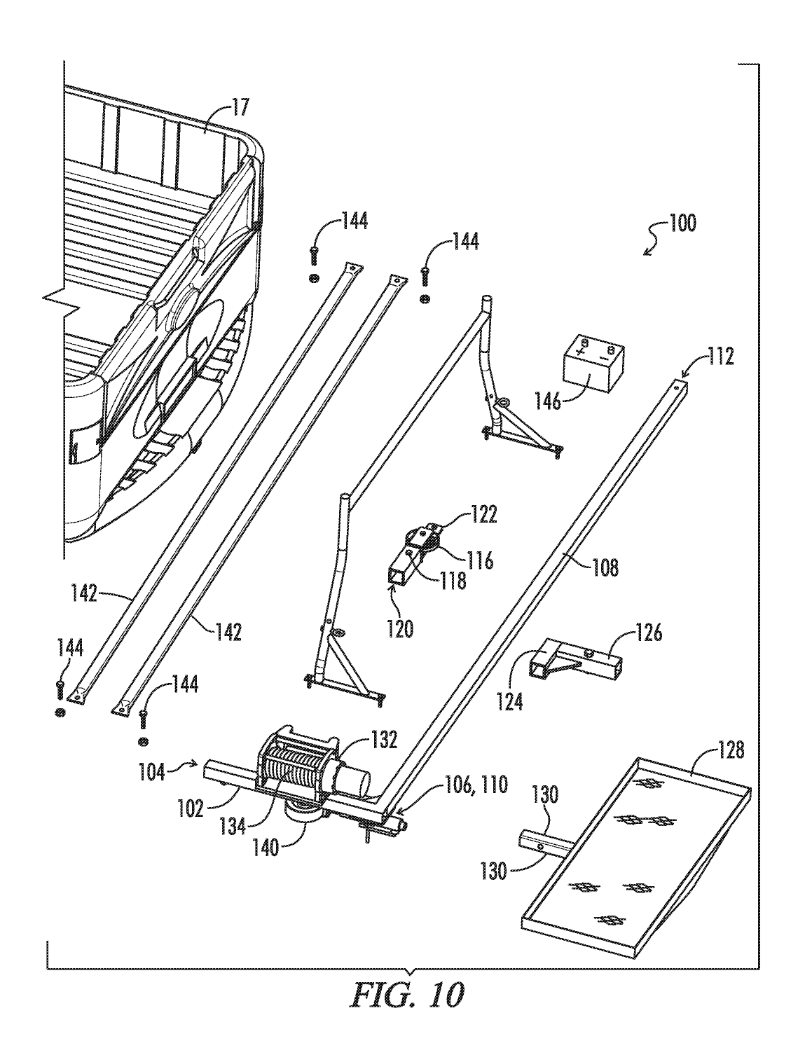

Turning now to FIGS. 6, and 10, the portable lift assembly 100 may include an attachment member 102. The attachment member 102 may be configured to engage the hitch 15 of the vehicle 17. The attachment member 102 may be tubular or solid and may include any appropriate materials including, but not limited to, metals, metal alloys, wood, polymers, composites, any combination thereof, and the like. In some embodiments, the attachment member may be a metal tubular member that includes an attachment end 104 that may be inserted into the hitch 15. Many embodiments include at least one fastener configured to removably connect the attachment member 102 to the hitch 15. The attachment member 102 may also include an assembly end 106 opposite the attachment end 104.

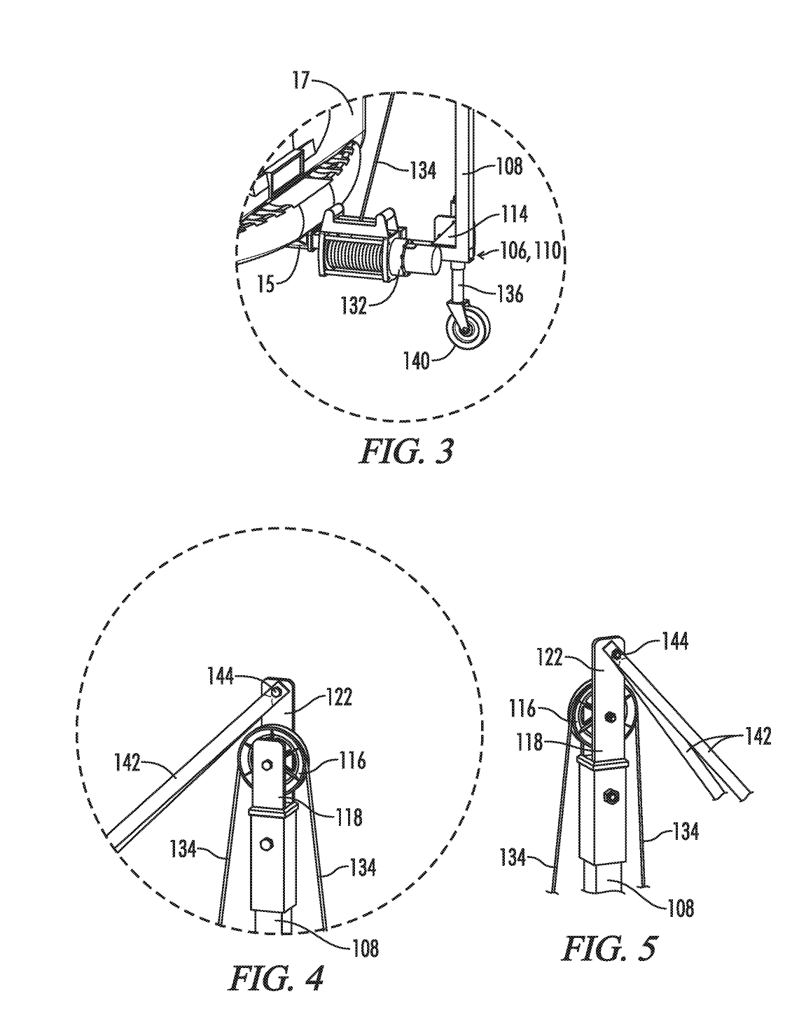

An elevation member 108 may be connected to the attachment member 102. The elevation member 108 may be tubular or solid and may include any appropriate materials including, but not limited to, metals, metal alloys, wood, polymers, composites, any combination thereof, and the like. The elevation member 108 may also be any appropriate length. In some embodiments, the elevation member 108 may be removably connected to the attachment member 102. In other embodiments, the elevation member 108 may be permanently connected to the attachment member 102 or integrally formed therewith. The elevation member 108 may include a proximal end 110 and a distal end 112. The distal end 112 may be opposite the proximal end 110. In many embodiments, the proximal end 110 of the elevation member 108 may be connected to the attachment member 102. In embodiments including the proximal end 110 of the elevation member 108 permanently connected to the attachment member 102, the proximal end of the elevation member and the assembly end 106 of the attachment member may be welded together. In embodiments having the proximal end 110 welded to the assembly end 106, at least one support plate 114 may also be welded to both the attachment member 102 and the elevation member 108 to add strength to the portable lift assembly 100 (shown in FIG. 3).

It is also contemplated that the elevation member 108 may be connected to a coupling that is attached to the attachment member 102 instead of being directly connected to the attachment member. In such an embodiment, a plurality of elevation members 108 of varying lengths may be provided. A user may select the elevation member 108 of the desired length for the task at hand, contemplating the clearance height of nearby structures and the required lifting height, and removably attach the selected elevation member to the coupling. This selection may avoid clearance issues for an elevation member 108 that may be much longer than required for a specific task.

As can best be seen in FIGS. 4 and 5, a pulley 116 may be disposed on the elevation member 108 nearer the distal end 112 than the proximal end 110. The pulley 116 may be removably attached to the elevation member 108, or the pulley may be permanently attached to the elevation member. In some embodiments, the pulley 116 may be connected to a pulley frame 118. The pulley frame 118 may be tubular or solid and may include any appropriate materials including, but not limited to, metals, metal alloys, wood, polymers, composites, any combination thereof, and the like. Shown particularly in FIG. 10, the pulley frame 118 may include a tubular body with an opening 120 defined therein to receive the distal end 112 of the elevation member 108. Once the elevation member 108 is inserted into the opening 120, at least one fastener may be configured to removably connect the elevation member to the pulley frame 118. Many embodiments also include the pulley frame 118 having a mounting extension 122. The mounting extension 122 may simply include a longer plate of the pulley frame 118. Details of the function of the mounting extension 122 will be described in more detail below.

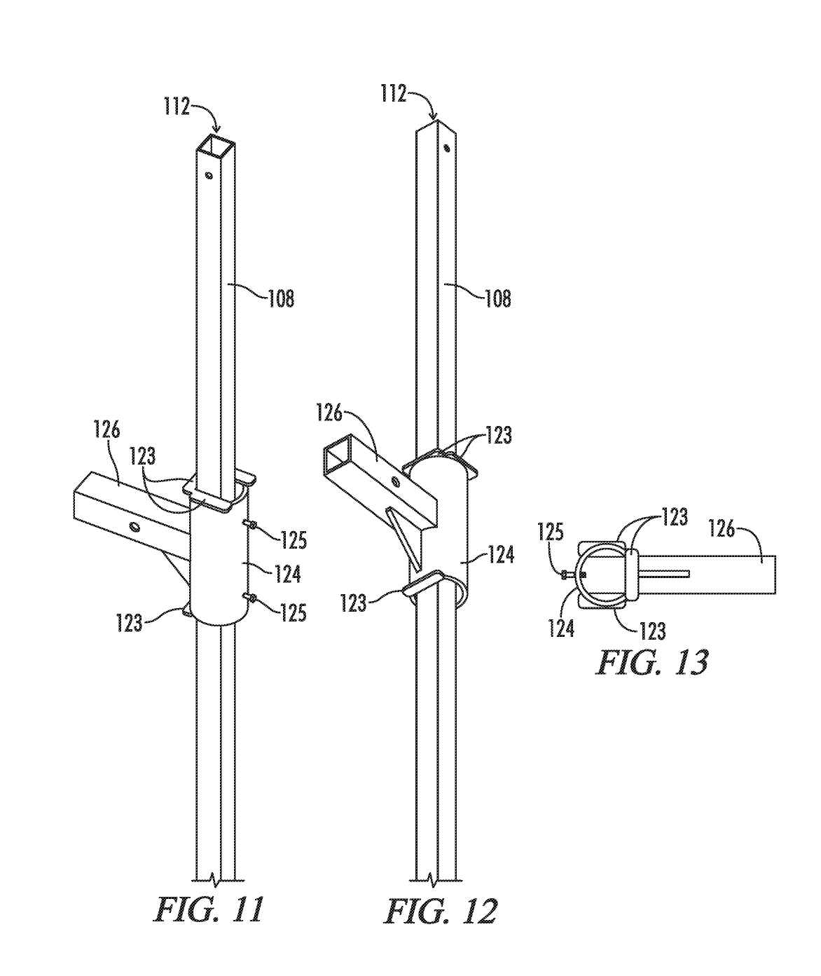

Turning now to FIGS. 10-13, many embodiments may include a sleeve member 124 slidably disposed on the elevation member 108. The sleeve member 124 may be tubular and may include any appropriate materials including, but not limited to, metals, metal alloys, wood, polymers, composites, any combination thereof, and the like. Tubular embodiments of the sleeve member 124 may include any appropriate shape including, but not limited to, prisms that are rectangular, circular, elliptical, triangular, pentagonal, hexagonal, octagonal, and the like. Some embodiments of the portable lift 100 may include more than one sleeve members 124 connected to one another or not connected to one another, and they may be disposed adjacent to one another or disposed a distance from one another along the elevation member 108. The sleeve member 124 and elevation member 108 may be of any appropriate construction to allow translational movement of the sleeve member along the length of the elevation member. In some embodiments, the sleeve member 124 is a tubular member that has an opening configured to receive the elevation member 108. At least one bearing, lubricant, post and rail assembly, and the like may further be included between the sleeve member 124 and the elevation member 108 to facilitate the translational movement. In some embodiments of the sleeve member 124, shown particularly in FIGS. 11-13, the sleeve member may include one or more bias plates 123. These bias plates 123 may facilitate in positioning the sleeve member 124 such that the sleeve member does not freeze against or bite into the elevation member 108. The sleeve member 124 may further include one or more bolts, or posts, 125 passing through the sleeve member and engaging the surface of the elevation member 108 to similarly facilitate in positioning the sleeve member.

A platform receiving member 126 may be connected to the sleeve member 124. The platform receiving member 126 may be tubular or solid and may include any appropriate materials including, but not limited to, metals, metal alloys, wood, polymers, composites, any combination thereof, and the like. In some embodiments, the platform receiving member 126 may be connected at a right angle to the sleeve member 124. Many embodiments include the platform receiving member 126 being welded to the sleeve member 124.

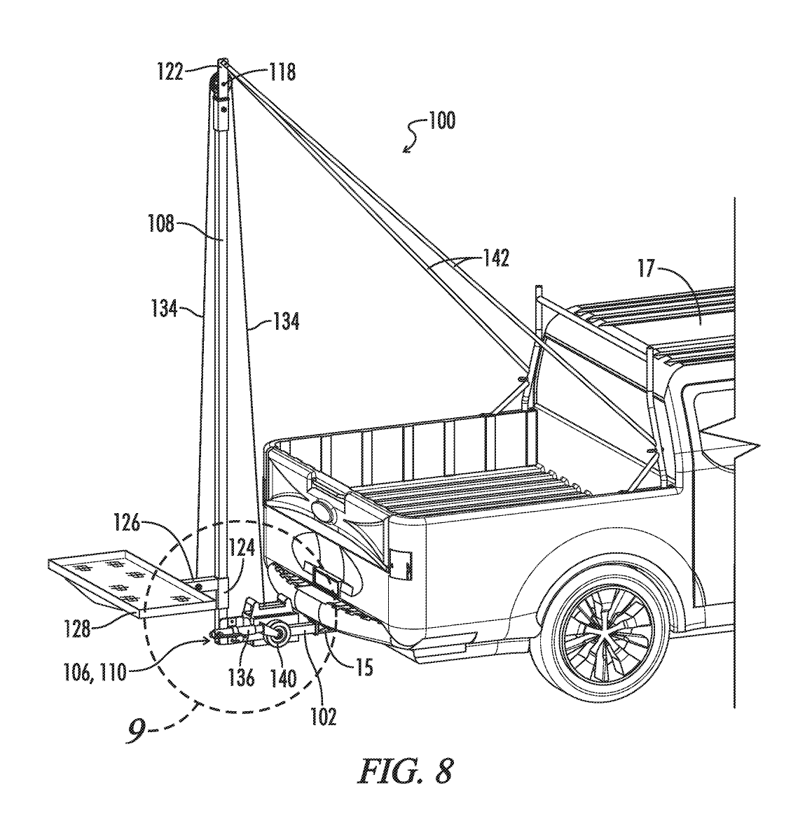

Turning now to FIGS. 8-10, the portable lift assembly 100 may further include a platform 128 connected to the platform receiving member 126. The platform 128 may include sections that may be tubular or solid and may include any appropriate materials including, but not limited to, metals, metal alloys, wood, polymers, composites, any combination thereof, and the like. In some embodiments, the platform 128 may be removably connected to the platform receiving member 126 with at least one fastener. One embodiment may include the platform 128 including two plates 130 configured to be disposed on either side of the platform receiving member 126. A fastener may extend through the plates 130 and the platform receiving member 126 to removably connect the platform 128 to the platform receiving member. In some embodiments, the two plates 130 may be parts of a tubular member configured to receive the platform receiving member 126.

In many embodiments, the platform 128 may be of a simple construction and include a substantially planar surface. Other embodiments having different platforms 128 with additional or alternative features are contemplated herein, however. For instance, in some embodiments, the platform 128 may include railings, a control interface to operate the portable lift assembly 100, tool attachment points, a gate for entry onto and exit from the platform, and the like.

Shown particularly in FIG. 3, the portable lift assembly 100 may further include a winch 132. The winch 132 may operate to raise and lower the platform 128 on the elevation member 108. The winch 132 may be mounted in any appropriate location, including somewhere in or on the vehicle 17. In some embodiments, the winch 132 may be removably or permanently mounted to the attachment member 102. A cable 134 (which may be any elongate flexible member including, but not limited to, ropes, chains, wires, cables, bands, and the like) may be wound around a drum of the winch 132. The cable 134 may also be attached to at least one of the sleeve member 124, the platform receiving member 126, and the platform 128. Further, the cable 134 may be disposed on the pulley 116. In some embodiments, the cable 134 may extend from the winch 132 to the pulley 116, around a portion of the pulley, and to one of the sleeve member 124, the platform receiving member 126, and the platform 128. The pulley 116 may offer a mechanical advantage such that the winch 132 may be smaller, may operate more quickly, or may operate with higher loads on the platform 128 when compared to an assembly without a pulley.

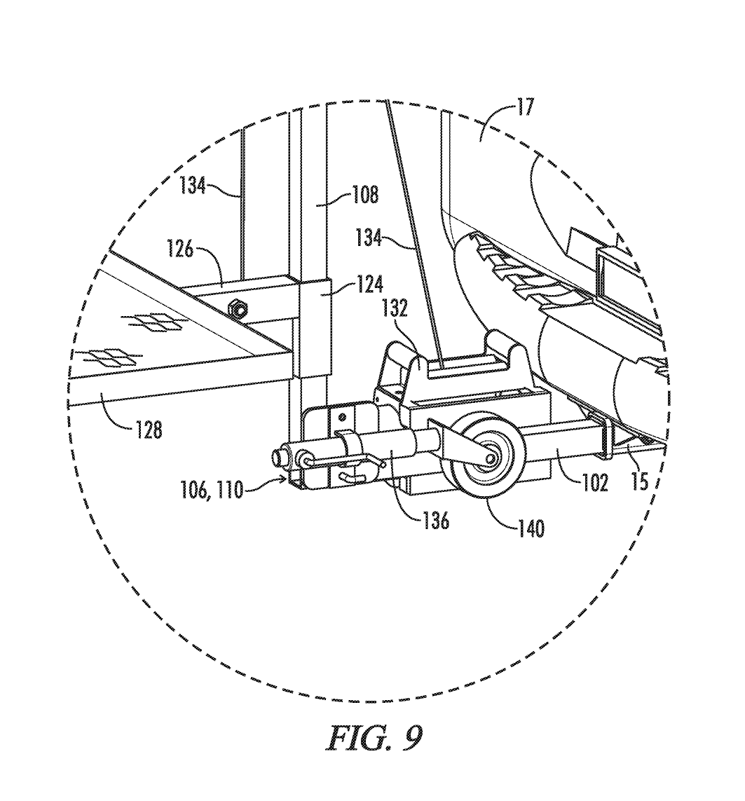

Turning now to FIGS. 3, 6, 7, and 9, the portable lift assembly 100 may also include a load dispersal member 136. The load dispersal member 136 may be tubular or solid and may include any appropriate materials including, but not limited to, metals, metal alloys, wood, polymers, composites, any combination thereof, and the like. The load dispersal member 136 may be removably or permanently connected to at least one of the attachment member 102 and the elevation member 108. In some embodiments, the load dispersal member 136 may be pivotably mounted to the attachment member 102. Additionally or alternatively, the load dispersal member 136 may be slidably mounted to the elevation member 108. In either configuration, the load dispersal member 136 may be configured to move from a storage position (shown in FIG. 9) to a deployed position (shown in FIG. 6). In the deployed position, a portion of the load dispersal member 136 may contact the ground. In such a configuration, load forces experienced by the portable lift assembly 100 may partially transfer into the ground instead of completely to the hitch 15.

As shown in FIG. 7, some embodiments may include the load dispersal member 136 having a foot 138 configured to engage the ground surface. The foot 138 may be removably or permanently connected to the load dispersal member 136. In many embodiments, the foot 138 may be configured to function as a ski for the portable lift assembly 100 when a user wishes to reverse the vehicle 17 to move the elevated platform 128, for example, over the edge of a roof 19 (shown in FIG. 1).

Other embodiments (shown in FIG. 6) including the load dispersal member 136 may include a wheel 140 connected to the load dispersal member. The wheel 140 may serve some or all of the same purposes as discussed above with regard to the foot 138. The wheel 140 may be of any appropriate manufacture. Some embodiments may include a wheel 140 such as a vehicle wheel or a spare tire wheel.

Turning to FIGS. 1, 2, 4, 5, 8, and 10, further embodiments of the portable lift assembly 100 may include at least one stabilizer member 142. The stabilizer members 142 may be tubular or solid and may include any appropriate materials including, but not limited to, metals, metal alloys, wood, polymers, composites, any combination thereof, and the like. Some embodiments of the stabilizer members 142 may include chains, cables, ropes, bands, wires, and the like. One embodiment may include rigid steel stabilizer members 142. Each stabilizer member 142 may be configured to be connected either directly or indirectly to the vehicle 17 at one end with at least one fastener 144 and either directly or indirectly to the portable lift assembly 100 at the other end. In many embodiments, the stabilizer members 142 may be removably connected to the mounting extension 122 of the pulley frame 118 with at least one fastener 144.

Referring now particularly to FIG. 10, any of the above described embodiments of the portable lift assembly 100 may further include a battery 146 to power the winch 132. Additionally or alternatively, the winch 132 may receive power from the vehicle 17 and/or from a power outlet via a power cord. In some embodiments, the winch 132 may include a power cord having a plug configured to fit in the trailer lights plug of the vehicle 17.

It will also be appreciated that the portable lift assembly 100 may be scaled up or down for particular applications. Of course, lifting roofing shingles may require a portable lift assembly 100 that is not as strong as what would be necessary for lifting one or more persons.

The portable lift assembly 100 may be used for various applications including, but not limited to, roofing, painting, cleaning gutters, tree trimming, displaying a billboard or sign, operating as a deer stand for hunting, and the like.

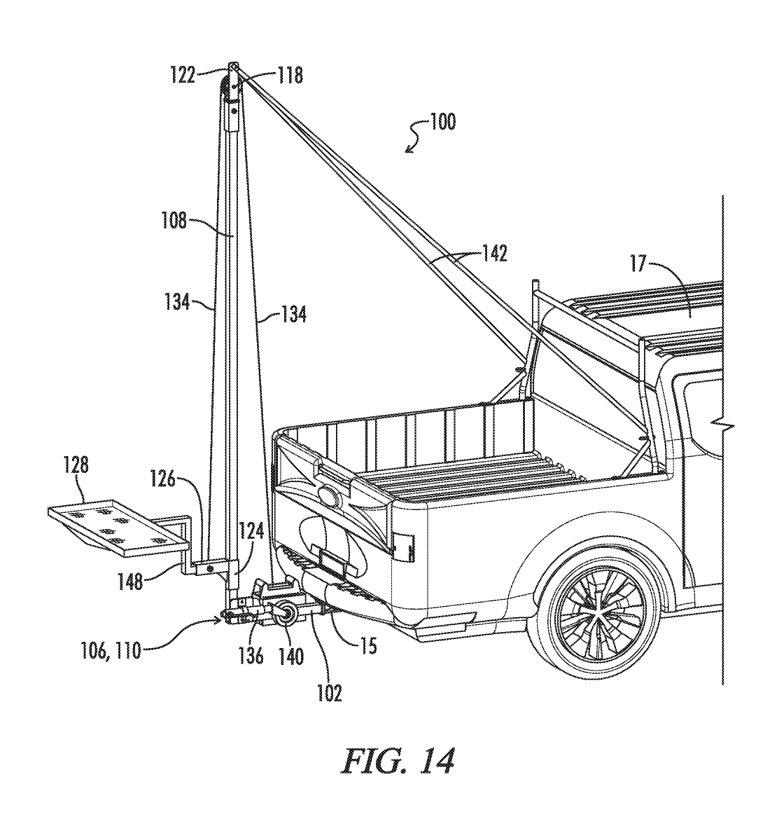

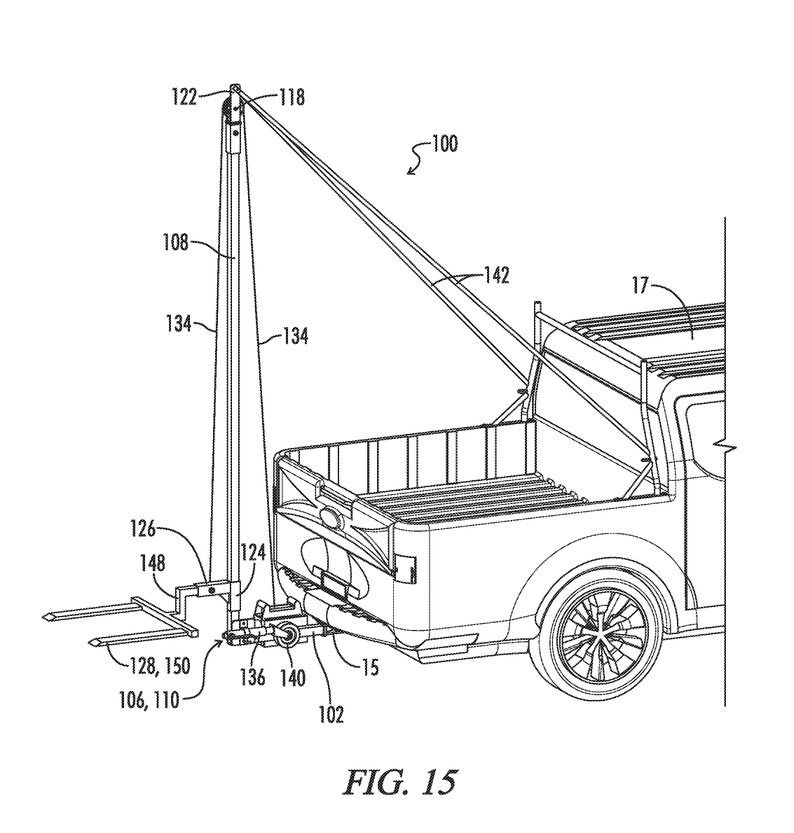

Turning now to FIGS. 14 and 15, the portable lift assembly 100 may further include the platform 128 slidably connected to the elevation member 108 with an extender 148. When the extender 148 is in the first configuration, as shown in FIG. 14, the extender may allow the platform 128 to move higher than what would normally be possible with a given elevation member 108. As shown in FIG. 15, the extender 148 may be placed in the second configuration. When in the second configuration, the extender 148 may allow the platform 128 to move lower than what would normally be possible. This lower position may be beneficial when loading a wheeled item onto the platform 128.

Further shown in FIG. 15, the platform 128 may include one or more tines 150 instead of the continuous surface shown in the other figures. These tines 150 may be sized and spaced such that they may engage a typical pallet. The vehicle 17 may effectively function as a forklift in such an embodiment. Of course, myriad versions of the platform 128 are contemplated herein, including a solid platform, a mesh platform, one or more tines 150, one or more hooks, an enclosure, any appropriate vessel for containing solids or liquids, some combination thereof, and the like.

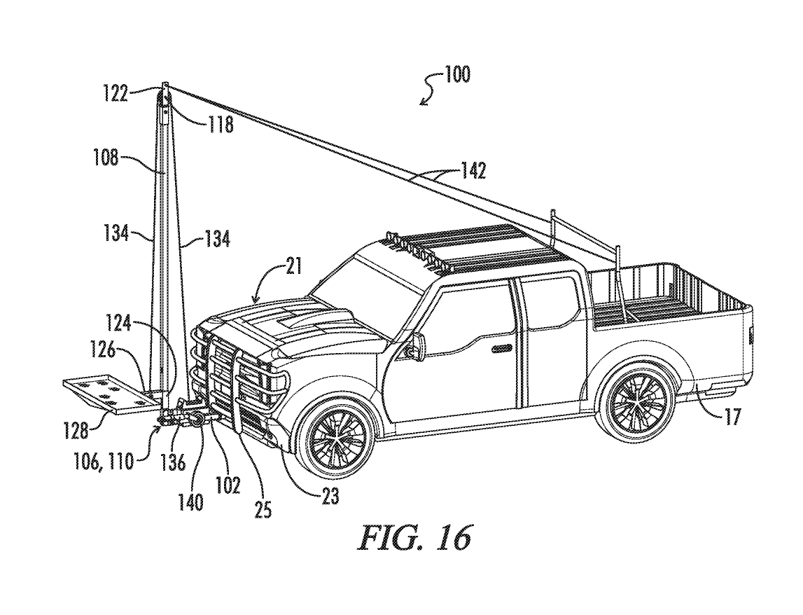

With reference to FIG. 16, some embodiments of the portable lift assembly 100 may be configured to be attached to a front portion 21 of the vehicle 17. In such embodiments, the attachment member 102 may be configured to connect to a hitch 15 at the front of the vehicle 17, a front bumper 23 of the vehicle, a front portion of the frame of the vehicle, a guard 25, some combination thereof, and the like. In embodiments including a guard 25, such as a brush guard, bumper guard, grille guard, and the like, the guard may also include the winch 132 disposed thereon. In some embodiments, the winch 132 may be a tow winch that typically comes with a guard 25 or is configured to be used with the guard.

This written description uses examples to disclose the invention and also to enable any person skilled in the art to practice the invention, including making and using any devices or systems. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Although embodiments of the disclosure have been described using specific terms, such description is for illustrative purposes only. The words used are words of description rather than limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. While specific uses for the subject matter of the disclosure have been exemplified, other uses are contemplated. Therefore, the spirit and scope of the appended claims should not be limited to the description of the versions contained herein.

1. A portable lift for attachment to a hitch of a vehicle, the portable lift comprising:
an attachment member configured to engage the hitch;
a single unitary elevation member having a proximal end and a distal end opposite the proximal end, the proximal end fixedly connected to the attachment member;
a platform slidably disposed on the elevation member;
a pulley disposed nearer the distal end than the proximal end of the elevation member; and
a winch configured to move the platform up and down on the elevation member, the winch including an elongate flexible member connected to the platform and engaging the pulley.

2. The portable lift of claim 1, further comprising:
a load dispersal member connected to at least one of the attachment member and the elevation member, the load dispersal member configured to engage a ground surface to transfer at least some downward force into the ground surface.

3. The portable lift of claim 2, wherein the load dispersal member includes a wheel configured to engage the ground surface.

4. The portable lift of claim 2, wherein the load dispersal member includes a foot configured to engage the ground surface.

5. The portable lift of claim 2, wherein the load dispersal member is rotatably connected to at least one of the attachment member and the elevation member.

6. The portable lift of claim 1, further comprising:
at least one stabilizer member connected to the elevation member, the at least one stabilizer member configured to attach to the vehicle to stabilize the elevation member.

7. The portable lift of claim 1, wherein the winch includes an electric winch.

8. The portable lift of claim 7, wherein the winch is configured to receive electrical energy from the vehicle.

9. The portable lift of claim 7, further comprising:
a battery; and
wherein the winch is configured to receive electrical energy from the battery.

10. The portable lift of claim 1, wherein the platform includes railing along at least some of a perimeter of the platform.

11. The portable lift of claim 1, wherein the elongate flexible member includes a cable.

12. The portable lift of claim 1, wherein the platform is connected to an extender, the extender slidably disposed on the elevation member.

13. The portable lift of claim 1, wherein the platform includes a mesh platform surface.

14. The portable lift of claim 1, wherein the platform includes one or more tines configured to engage a pallet.

15. The portable lift of claim 1, wherein the winch is connected to the attachment member.

16. A portable lift for attachment to a front portion of a vehicle, the portable lift comprising:
an attachment member configured to engage the front portion of the vehicle;
an elevation member having a proximal end and a distal end opposite the proximal end, the proximal end connected to the attachment member;
a platform slidably disposed on the elevation member;
a pulley disposed nearer the distal end than the proximal end of the elevation member; and
a winch configured to move the platform up and down on the elevation member, the winch including an elongate flexible member connected to the platform and engaging the pulley.

17. The portable lift of claim 16, wherein the attachment member is configured to engage a portion of a guard connected to the vehicle.

18. The portable lift of claim 17, wherein the winch is mounted to the guard.

19. The portable lift of claim 16, further comprising:
at least one stabilizer member connected to the elevation member, the at least one stabilizer member configured to attach to the vehicle to stabilize the elevation member.

20. A method of operating a portable lift, the method comprising:
(a) providing a vehicle having a hitch;
(b) securing an attachment member of the portable lift to the hitch;
(c) operating a winch in a first direction, thereby slidably translating a platform along a single unitary elevation member in an upward direction;
(d) operating the winch in a second direction, thereby slidably translating the platform along the elevation member in a downward direction; and
(e) maintaining the platform opposite the elevation member from the hitch during use of the portable lift.
